(19) United States
(12) Patent Application Publication
(10) Pub. No.: US 2022/0174528 A1
(43) Pub. Date: Jun. 2, 2022

(54) METHODS FOR FLEXIBLE CLI MEASUREMENT REPORTING

(71) Applicant: Telefonaktiebolaget LM Ericsson (publ), Stockholm (SE)

(72) Inventors: Jonas Sedin, Sollentuna (SE); Petter Ersbo, Knivsta (SE); Sebastian Faxér, Stockholm (SE); Naga Vishnu Kanth Irukulapati, Västra Frölunda (SE)

(21) Appl. No.: 17/433,001

(22) PCT Filed: Feb. 22, 2020
(86) PCT No.: PCT/IB2020/051498

§ 371 Date: Aug. 23, 2021

Related U.S. Application Data
(60) Provisional application No. 62/809,446, filed on Feb. 22, 2019.

(51) Int. Cl. H04W 24/10; H04W 24/08; H04L 5/00

(52) U.S. Cl. CPC H04W 24/10; H04L 5/0048; H04W 24/08

(57) ABSTRACT

Systems and methods for flexible Cross-Link Interference (CLI) measurement reporting are provided. In some embodiments, a method performed by a wireless device for performing CLI measurements includes the wireless device receiving at least one CLI measurement configuration. The CLI measurement configuration includes a measurement resource and one or more resource Identities (IDs) of the measurement resource instead of the physical cell ID. The wireless device performs measurements on the measurement resource based on the CLI measurement configuration. Upon detecting that one of the measurements exceeds a threshold, the wireless device transmits a measurement report. The measurement report includes the measurement that exceeds the threshold and the one or more resource IDs of the respective measurement resource. This might allow for more flexible CLI reporting by enabling comparison of a range of different conditions so that the measurement reporting criteria may better detect scenarios where the CLI is an issue.

### RELATED APPLICATIONS

This application claims the benefit of provisional patent application Ser. No. 62/809,446, filed Feb. 22, 2019, the disclosure of which is hereby incorporated herein by reference in its entirety.

### TECHNICAL FIELD

The current disclosure relates to performing and reporting measurements.

### BACKGROUND

Wireless cellular networks are built up of cells, each cell defined by a certain coverage area of a Network Node (NN). The NN communicates with user equipment (UE) in the network wirelessly. The communication is carried out in either paired or unpaired spectrum. In the case of paired spectrum, the Downlink (DL) and Uplink (UL) directions are separated in frequency, called Frequency Division Duplex (FDD). In the case of unpaired spectrum, the DL and UL use the same spectrum, called Time Division Duplex (TDD). As the name implies, the DL and UL are separated in the time domain, typically with a Guard Period (GP) between them. A GP serves several purposes. Most essentially, the processing circuitry at the NN and UE needs sufficient time to switch between transmission and reception; however this is typically a fast procedure and does not significantly contribute to the requirement of the GP size. There is one GP at a DL-to-UL switch and one GP at an UL-to-DL switch, but since the GP at the UL-to-DL switch only needs to give enough time to allow the NN and the UE to switch between reception and transmission, and consequently typically is small, it is neglected in the following description for simplicity. The GP at the DL-to-UL switch, however, must be sufficiently large to allow a UE to receive a (time-delayed) DL grant scheduling the UL and transmit the UL signal with proper timing advance (compensating for the propagation delay) such that it is received in the UL part of the frame at the NN (in fact, the GP at the UL-to-DL switch is created with an offset to the timing advance). Thus, the GP should be larger than two times the propagation time towards a UE at the cell edge; otherwise, the UL and DL signals in the cell will interfere. Because of this, the GP is typically chosen to depend on the cell size such that larger cells (i.e., larger inter-site distances) have a larger GP and vice versa.

Additionally, the GP reduces DL-to-UL interference between NNs by allowing a certain propagation delay between cells without having the DL transmission of a first NN enter the UL reception of a second NN. In a typical macro network, the DL transmission power can be on the order of 20 dB larger than the UL transmission power, and the pathloss between NNs, perhaps above roof top and in line of sight (LOS), may be much smaller than the pathloss between NNs and UEs (in non-LOS). Hence, if the UL is interfered by the DL of other cells, so called Cross-Link Interference (CLI), the UL performance can be seriously degraded. Because of the large transmit power discrepancy between UL and DL and/or propagation conditions, CLI can be detrimental to system performance not only for the co-channel case (where the DL interferes with the UL on the same carrier) but also for the adjacent channel case (where the DL of one carrier interferes with the UL on an adjacent carrier). Additionally, CLI could be both DL-to-UL (Base Station (BS)-to-BS) and UL-to-DL (UE-to-UE). Because of this, TDD macro networks are typically operated in a synchronized and aligned fashion where the symbol timing is aligned and a semi-static TDD UL/DL pattern is used which is the same for all the cells in the NW; by aligning UL and DL periods so that they do not occur simultaneously, the interference between UL and DL is reduced. Typically, operators with adjacent TDD carriers also synchronize their TDD UL/DL patterns to avoid adjacent channel CLI. Improved systems and methods for CLI measurement are needed.

### SUMMARY

Systems and methods for flexible Cross-Link Interference (CLI) measurement reporting are provided. In some embodiments, a method performed by a wireless device for performing CLI measurements includes the wireless device receiving at least one CLI measurement configuration. The CLI measurement configuration includes a measurement resource and one or more resource IDs of the measurement resource instead of the physical cell ID. The wireless device performs measurements on the measurement resource based on the CLI measurement configuration. Upon detecting that the measurement exceeds a threshold, the wireless device transmits a measurement report. The measurement report includes the measurement that exceeds the threshold and the one or more resource IDs of the respective measurement resource. In this way, different reference signals might be compared with each other; different measures might be compared with each other; and/or resource IDs may be reported instead of physical cell IDs. This might allow for more flexible CLI reporting by enabling comparison of a range of different conditions so that the measurement reporting criteria may better detect scenarios where the CLI is an issue.

In some embodiments, a method performed by a base station for receiving CLI measurements includes transmitting, to a wireless device, at least one CLI measurement configuration comprising a measurement resource and one or more resource IDs of the measurement resource instead of the physical cell ID; and receiving a measurement report, where the measurement report comprises a measurement that exceeds a threshold and the one or more resource IDs of the respective measurement resource.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications network 100, according to some embodiments of the present disclosure;

FIG. 2 illustrates applying a Guard Period (GP), at the Downlink (DL)-to-Uplink (UL) switch, to avoid DL-to-UL interference, according to some embodiments of the present disclosure;

FIG. 3 illustrates two cells having different traffic directions, User Equipment 1 (UE1) in DL is interfered by UE2, according to some embodiments of the present disclosure;

FIG. 4 illustrates different network nodes using different transmission directions in different symbols, according to some embodiments of the present disclosure;

FIG. 5 illustrates a measurement reporting framework, according to some embodiments of the present disclosure;

FIG. 6 is a schematic block diagram of a radio access node according to some embodiments of the present disclosure;

FIG. 7 is a schematic block diagram that illustrates a virtualized embodiment of the radio access node according to some embodiments of the present disclosure;

FIG. 8 is a schematic block diagram of the radio access node according to some other embodiments of the present disclosure;

FIG. 9 is a schematic block diagram of a UE according to some embodiments of the present disclosure; and

FIG. 10 is a schematic block diagram of the UE according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

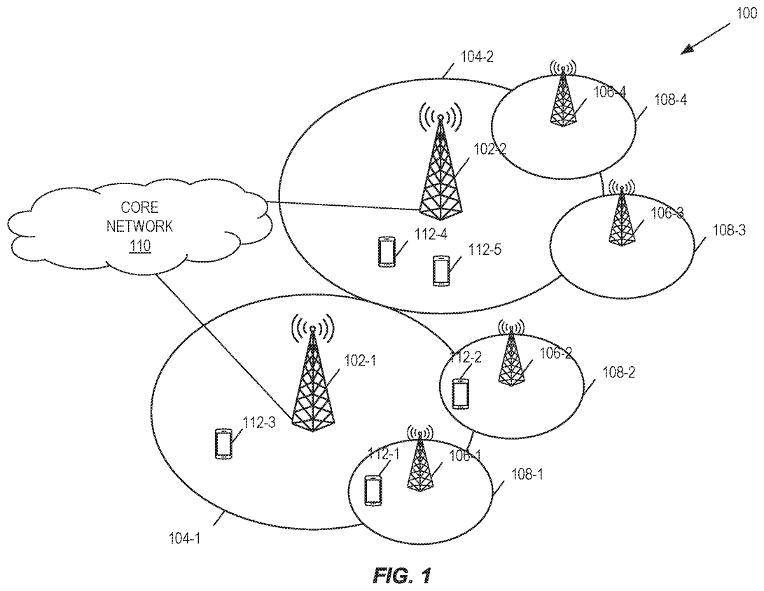

FIG. 1 illustrates one example of a cellular communications network 100. In the embodiments described herein, the cellular communications network 100 is a 5G NR network. In this example, the cellular communications network 100 includes base stations 102-1 and 102-2, which in LTE are referred to as eNBs and in 5G NR are referred to as gNBs, controlling corresponding macro cells 104-1 and 104-2. The base stations 102-1 and 102-2 are generally referred to herein collectively as base stations 102 and individually as base station 102. Likewise, the macro cells 104-1 and 104-2 are generally referred to herein collectively as macro cells 104 and individually as macro cell 104. The cellular communications network 100 may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The base stations 102 (and optionally the low power nodes 106) are connected to a core network 110. The base stations 102 and the low power nodes 106 provide service to wireless devices 112-1 through 112-5 in the corresponding cells 104 and 108. The wireless devices 112-1 through 112-5 are generally referred to herein collectively as wireless devices 112 and individually as wireless device 112. The wireless devices 112 are also sometimes referred to herein as UEs.

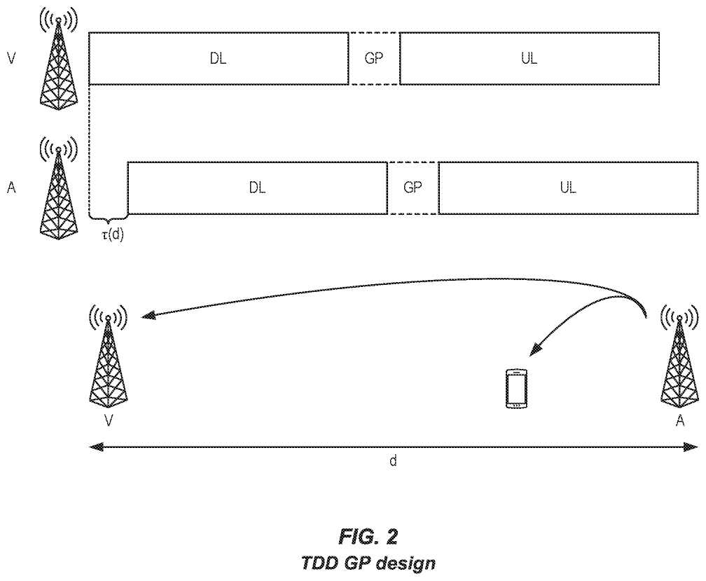

The principle of applying a Guard Period (GP), at the DL-to-UL switch, to avoid Downlink (DL)-to-Uplink (UL) interference between Network Nodes (NNs) is shown in FIG. 2 where a victim NN (V) is being (at least potentially) interfered by an aggressor NN (A). The aggressor sends a DL signal to a device in its cell, the DL signal also reaches the victim NN (the propagation loss is not enough to protect it from the signals of A) which is trying to receive a signal from another terminal (not shown in the figure) in its cell. The signal has propagated a distance (d) and due to propagation delay, the experienced frame structure alignment of A at V is shifted/delayed τ second, proportional to the propagation distance d. As shown in the figure, although the DL part of the aggressor NN (A) is delayed, it does not enter the UL region of the victim (V) thanks to the GP. The system design serves its purpose. As a side note, the aggressor DL signal does of course undergo attenuation, but may be very high relative to the received victim UL signal due to differences in transmit powers in terminals and NNs, as well as propagation condition differences for NN-to-NN links and UE-to-NN links.

It could be noted that the terminology victim and aggressor are only used here to illustrate why typical TDD systems are designed as they are. The victim can also act as an aggressor and vice versa and even simultaneously since channel reciprocity exists between the NN.

The radio access technology (RAT) next generation mobile wireless communication system (5G) or NR supports a diverse set of use cases and a diverse set of deployment scenarios. The latter includes deployment at both low frequencies (100s of MHz), similar to the RAT LTE today, and very high frequencies (mm waves in the tens of GHz).

As shown in Table 1, seven different DL/UL configurations are supported for FS 2. Here, “D” denotes a DL SF, “U” denotes an UL SF, and “S” represents a special SF. Configurations 0, 1, 2, and 6 have 5 ms DL-to-UL switch-point periodicity, with the special SF exists in both SF 1 and SF 6. Configurations 3, 4, and 5 have 10 ms DL-to-UL switch-point periodicity, with the special SF in SF 1 only.

Table 1
LTE UL-DL configurations (from 36.211, Table 4.2-2)

| | DL-to-UL | | | | | | | | | | | |
|---|---|---|---|---|---|---|---|---|---|---|---|---|
| UL-DL | Switch-point | | Subframe number | | | | | | | | | |
| configuration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

NR supports dynamic TDD, that is, dynamic signalling of the DL, Flexible, and UL allocation on symbol level for one or multiple slots to a group of UEs by using a Slot Format Indicator (SFI) in the Downlink Control Information (DCI) carried on a group-common Physical Downlink Control Channel (PDCCH) (DCI Format 2_0). The SFI field in a DCI format 2_0 indicates a group of UEs in a slot format for each slot in a number of slots starting from a slot where the DCI format 2_0 is detected.

A slot format is identified by a corresponding format index as provided in Table 11.1.1-1 of 3GPP TS 38.213, where ‘D’ denotes a downlink symbol, ‘U’ denotes an uplink symbol, and ‘F’ denotes a flexible symbol.

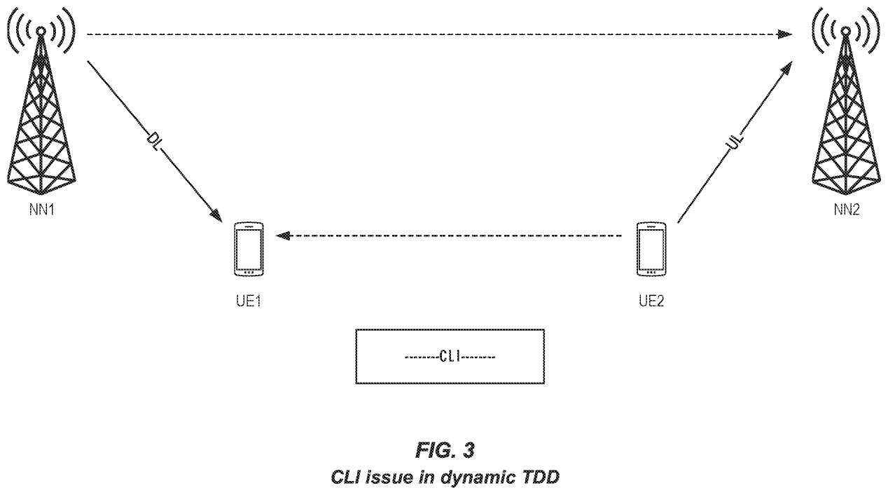

The support for dynamic TDD enables NR to maximally utilize available radio resource in the most efficient way for both traffic directions. Although dynamic TDD brings significant performance gain at low to medium loads, the performance benefits become smaller as the traffic load increases due to CLI. As shown in FIG. 3, if two cells have different traffic directions, UE1 in DL experiences very strong interference from UE2 which can be closer to UE1 than the serving NN1. From NN2 in UL perspective, NN2 will also experience interference from NN1 since NN1 is transmitting (DL). CLI is the main impediment to performance gains from dynamic TDD operation at higher loads as compared to static TDD. Most solutions to minimize the CLI involve defining signaling between NNs to exchange information regarding the sources and the levels of interference in the operator network.

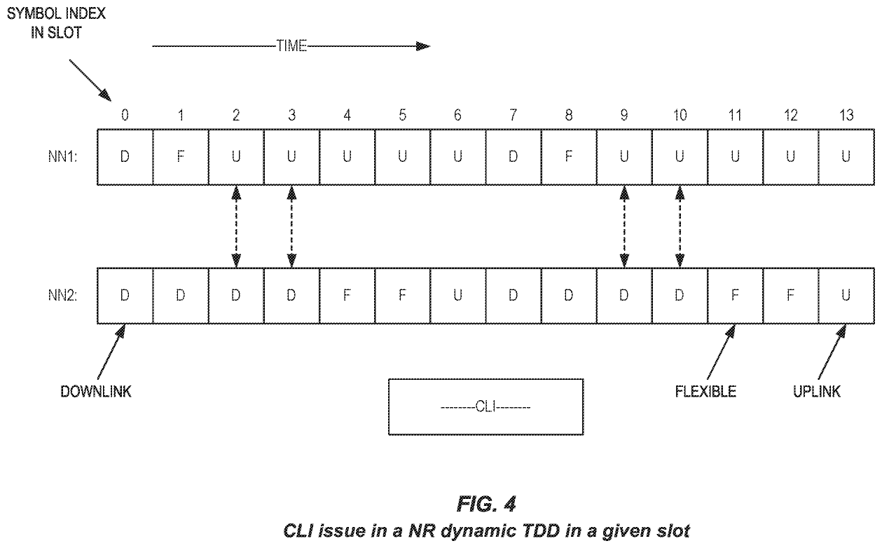

The situation can also be illustrated on a symbol level where the different NNs use different transmission directions in different symbols, see FIG. 4, assuming that in a given slot, the format index 48 (of Table 11.1.1-1 of 3GPP TS 38.213) is configured for the UEs in NN1 and the format index 49 (of Table 11.1.1-1) is configured for the UEs in NN2. The situation shown in FIG. 3 occurs in symbol index 2, 3, 9, and 10 in FIG. 4.

To assist the operator in understanding the pathloss between NNs and UEs, measurements can be adopted. These measurements can be based on for example the total received signal, e.g., Received Signal Strength Indicator (RSSI), or the received signal strength from a specific (set of) transmitting NN/UE, e.g., Received Signal Reference Power (RSRP).

The measurement report framework sets up the UE to report whenever a configured condition is fulfilled, according to a set of conditions A1-A6 and B1-B2. The conditions A1 and A3 are for instance defined as:
Event A1: Serving cell becomes better than an absolute threshold;
Event A3: Neighbour cell becomes better than an offset relative to the serving cell.

When the configured condition is fulfilled, the UE will report the measurements and the identities that triggered the measurement report.

The measurement configuration can be divided into five parts. 1) Measurement objects: A measurement object defines on what the UE should perform the measurements. The measurement object may include a list of cells to be considered. 2) Reporting Configurations: A reporting configuration consists of the reporting criteria that trigger the UE to send a measurement report which is a single event or periodical, the reference signal type and the reporting format. 3) Measurement identities: These identify a measurement and define the applicable measurement object and reporting configuration. 4) Quantity configurations: The quantity configuration defines the filtering to be used on each measurement. 5) Measurement gaps: Measurement gaps define time period when no uplink or downlink transmissions will be scheduled, so that the UE may perform the measurements required by the network.

Examples of NNs are NodeB, Base Station (BS), Integrated Access and Backhaul (IAB) node, Multi-Standard Radio (MSR) radio node such as MSR BS, eNB, gNB. MeNB, SeNB, network controller, Radio Network Controller (RNC), Base Station Controller (BSC), Road Side Unit (RSU), relay, donor node controlling relay, Base Transceiver Station (BTS), Access Point (AP), transmission points, transmission nodes, Remote Radio Unit (RRU), Remote Radio Head (RRH), nodes in Distributed Antenna System (DAS), core network node (e.g., a Mobile Switching Center, Mobility Management Entity, etc.), Operation & Maintenance, Operations Support System, Self-Organizing Network, positioning node (e.g., Evolved Serving Mobile Location Center (E-SMLC) etc.

A UE can be generalized to correspond to a user terminal, or a network node like a relay node or an IAB node.

A UL can be generalized to correspond to a UL in the access link, and UL in the backhaul link. Similarly, a DL can be generalized to correspond to a DL in the access link, and DL in the backhaul link.

The term radio access technology, or RAT, may refer to any RAT e.g., Universal Terrestrial Radio Access, Evolved Universal Terrestrial Radio Access, narrow band internet of things (NB-IoT), WiFi, Bluetooth, next generation RAT (NR), 4G, 5G, etc. Any of the first and the second nodes may support a single or multiple RATs.

The term signal used herein can be any physical signal or physical channel. Examples of downlink physical signals are Reference Signals such as Primary Synchronization Signal, Secondary Synchronization Signal, Cell Specific Reference Signal, Positioning Reference Signal, Channel State Information Reference Signal (CSI-RS), Demodulation Reference Signal (DMRS), Narrowband Reference Signal, Narrowband Internet of Things Primary Synchronization Signal, Narrowband Internet of Things Secondary Synchronization Signal, Synchronization Signal, Multicast-Broadcast Single Frequency Network, Reference Signal, etc. Examples of uplink physical signals are RSs such as Sounding Reference Signals, DMRSs etc. The term physical channel (e.g., in the context of channel reception) used herein is also called as “channel”. The physical channel carries higher layer information (e.g., Radio Resource Control (RRC), logical control channel etc.).

An example measurement configuration that uses a physical cell Identity (ID) is shown below:

| | |
|---|---|
| MeasResultNR ::= | SEQUENCE { |
| physCellId | PhysCellId |

OPTIONAL,

| | |
|---|---|
| measResult | SEQUENCE { |
| cellResults | SEQUENCE{ |
| resultsSSB-CelI | MeasQuantityResults |

OPTIONAL,

| | |
|---|---|
| resultsCSI-RS-Cell | MeasQuantityResults |

OPTIONAL
},

| | |
|---|---|
| rsIndexResults | SEQUENCE{ |
| resultsSSB-Indexes | ResultsPerSSB-IndexList |

OPTIONAL,

| | |
|---|---|
| resultsCSI-RS-Indexes | ResultsPerCSI-RS-IndexList |

```
OPTIONAL
    }
OPTIONAL
  },
  ...,
  [[
```

| | |
|---|---|
| cgi-Info | CGI-Info |

OPTIONAL
]]
}

For the measurement report triggering, for the conditions A1-A6 and B1-B2, the measured quantity, thresholds, and offsets are always of the same kind of reference signal type and same quantity. For instance, for the A3 event:
Event A3: Neighbour cell becomes better than an offset relative to the serving cell.

If for instance the UE is configured to measure CSI-RS and RSRP, the A3 event shall be interpreted as:
Event A3: Neighbour CSI-RS RSRP becomes better than an offset relative to the serving CSI-RS RSRP.

The A3 event will compare neighbouring reference signals with the serving cell reference signal and they will both use the same measure, i.e., RSRP, Reference Signal Received Quality (RSRQ), or Signal to Interference Plus Noise Ratio (SINR) and they will compare the same reference signal i.e., Synchronization Signal Block (SSB) or CSI-RS.

The term CLI measurement report might be generalized to a/any measurements report, not necessarily related to CLI, although the current disclosure introduces them in this context.

There currently exist certain challenges. For current measurement reporting configuration, the network is only able to report measurements of physical cell IDs. For CLI measurement purpose, there is a need to measure UE-to-UE signal strength or signal quality, meaning that some IDs other than the cell ID need to be reported. In the case of CLI-measurements, more flexibility could be needed in order to detect the CLI issues.

Certain aspects of the present disclosure and their embodiments may provide solutions to the aforementioned or other challenges. For instance, in some embodiments disclosed herein, CLI measurement reporting is made more flexible using the RRC measurement reporting framework enabling one or more of the following:
Different reference signals may be compared with each other;
Different measures may be compared with each other;
Resource IDs may be reported instead of physical cell IDs.

There are, proposed herein, various embodiments which address one or more of the issues disclosed herein. In some embodiments, a UE is configured with a CLI measurement that allows for comparison of different reference signals and measurement quantities and transmits the report to the network node. In some embodiments, a method performed by a wireless device for performing CLI measurements is provided. The method includes detecting a measurement report trigger; and transmitting a measurement report. In some embodiments, a method performed by a base station for receiving CLI measurements is provided. The method includes configuring a wireless device with CLI measurement configurations; and receiving a measurement report from the wireless device.

Certain embodiments may provide one or more of the following technical advantage(s). The embodiments disclosed herein allow for a more flexible CLI reporting by enabling comparison of a range of different conditions so that the measurement reporting criteria may better detect scenarios where the Cross Link Interference is an issue.

FIG. 5 illustrates a measurement reporting framework, according to some embodiments of the present disclosure. The wireless device receives at least one CLI measurement configuration from a base station. The CLI measurement configuration includes a measurement resource and one or more resource identities (IDs) of the measurement resource instead of the physical cell ID (step 500). The wireless device performs measurements on the measurement resource based on the CLI measurement configuration (step 502). Upon detecting that one of the measurements exceeds a threshold (step 504), the wireless device transmits a measurement report (step 506). The measurement report includes the measurement that exceeds the threshold and the one or more resource IDs of the respective measurement resource. In some embodiments, the wireless device detects some other measurement report trigger.

A method performed by a base station for receiving CLI measurements is also illustrated in FIG. 5. In some embodiments, the base station transmits, to a wireless device, at least one CLI measurement configuration (step 500). This CLI measurement configuration includes a measurement resource and one or more resource D, of the measurement resource instead of a physical cell ID. After the steps discussed above in relation to the wireless device, the base station receives a measurement report, where the measurement report includes a measurement that exceeds a threshold and the one or more resource IDs of the respective measurement resource (step 506).

In some embodiments, step 502 may include, for example, the total received signal, e.g., RSSI, or the received signal strength from a specific (set of) transmitting NN/UE, e.g., RSRP. In some embodiments, these measurements include measuring a RSRP of a SRS transmitted by a neighboring wireless device and a RSRP of a downlink reference signal transmitted by a serving cell of the neighboring wireless device. In some embodiments, the measurements include measuring a RSRP of a downlink reference signal transmitted by the current serving cell or of a downlink reference signal transmitted by a cell serving an aggressor wireless device. In some embodiments, the downlink reference signal measured is a Channel State Information—Reference Signal (CSI-RS) and/or a Synchronization Signal Block (SSB).

In some embodiments, step 504 may include, for example, comparing a RSRP of a SRS transmitted by a neighboring wireless device with a RSRP of a downlink reference signal transmitted by a serving cell of the neighboring wireless device. In some embodiments, the comparison is a comparison of different types of reference signals. In some embodiments, exceeding a threshold is based on detecting that the measurement becomes an offset larger than a RSRP of a downlink reference signal transmitted by the current serving cell and/or a downlink reference signal transmitted by a cell serving an aggressor wireless device. In some embodiments, comparison is done in singular, i.e., one signal is compared to another signal. However, in some embodiments, multiple comparisons on different reference signals will be performed.

In some embodiments, a triggering condition can be used for determining when to send a measurement report. For example, when one measurement exceeds a threshold, then a measurement report can be sent to the network node. In another example, for CLI measurement purposes, a victim UE may be configured to monitor periodic SRS transmissions by other, potential aggressor, UEs and calculate SRS-RSRP for each monitored SRS. The SRS-RSRP could be periodically reported by the UE to the network. A downside to this solution is that the resulting reporting overhead could be quite large and the messages comprising the SRS-RSRP reports would have to be transmitted frequently. In many cases, the information conveyed by the reports would not be relevant for the network either. The network may only be interested in knowing if a certain UE is experiencing high CLI towards some other neighboring UE, so that scheduling those UEs simultaneously can be avoided. This would typically happen when two UEs in neighboring cells are located in close proximity to each other. That is, for most victim/aggressor UE combinations, the link, and thus the measured SRS-RSRP would be relatively low while for some victim/aggressor UE combinations, the link could be very strong (and hence the measured SRS-RSRP would be relatively large). Therefore, it could be warranted to apply some event-based reporting and only report SRS-RSRP corresponding to those victim/aggressor UE links which are sufficiently strong.

However, it is not clear how “sufficiently strong” should be defined in a straightforward manner that can be used to define a clear criterion for the event-based report. In typical operation, UL-to-DL CLI only results in a detrimental impact to the system if the interference level from the cross-link is substantially larger than that of regular DL-to-DL interference. Therefore, it may be sensible to compare the RSRP of an SRS transmitted by a neighboring UE with the RSRP of a DL reference signal transmitted by the neighboring UEs serving cell.

In some embodiments, the CLI measurement report triggering condition can be defined based on a comparison of different types of reference signals. For instance, the SRS-RSRP is only reported when it becomes an offset larger than the RSRP of a DL reference signal transmitted by another cell. In a typical embodiment, the reference signal may be a reference signal transmitted by the same neighboring cell as the cell which the aggressor UE transmitting the corresponding SRS is served by. In other embodiments, the cell may be the victim UE's serving cell. The DL reference signal may for instance be a CSI-RS or an SSB. That is the SRS-RSRP is compared against a CSI-RSRP or an SSB-RSRP.

A non-limiting example of the existing measurement setup could be extended to encompass this aspect of the embodiments disclosed herein and is presented below:

| | |
|---|---|
| EventTriggerConfig::= | SEQUENCE { |
| eventId | CHOICE { |

. . .

| | |
|---|---|
| rsType | NR-RS-Type, |
| reportInterval | ReportInterval, |
| reportAmount | ENUMERATED {r1, r2, r4, r8, r16, r32, r64, infinity}, |
| reportQuantityCell | MeasReportQuantity, |
| maxReportCells | INTEGER (1..maxCellReport), |
| reportQuantityRS-Indexes | MeasReportQuantity |

OPTIONAL, -- Need R

| | |
|---|---|
| maxNrofRS-IndexesToReport | INTEGER (1..maxNrofIndexesToReport) |

OPTIONAL, -- Need R

| | |
|---|---|
| includeBeamMeasurements | BOOLEAN, |
| reportAddNeighMeas | ENUMERATED {setup} |

OPTIONAL, -- Need R

| | |
|---|---|
| rsTypeReference | NR-RS-Type, |

...
}

Since the RSRPs from two different RS Types are compared, it may not be straightforward to do a direct comparison. Therefore, in one embodiment, the event trigger definition may comprise an RS-Type specific offset, which may be pre-defined in the standard specification for each possible different RS Type pair that is compared, or it may be explicitly configured as part of the measurement configuration. In other embodiments, the RS-Type specific offset may only be implicitly signaled as part of the general offset, which is configured as part of the event definition.

In another embodiment, the comparison of different types of reference signals may be achieved by extending existing 3GPP standard Release 15 measurement reporting conditions A1-A6, rather than defining a new Event. As an example, if different RS signals are compared, Event A3 may be interpreted as the following:
Event A3: Neighbouring SRS-RSRP resource ID becomes offset better than PCell/PSCell CSI-RSRP.

In another embodiment, RSSI is used as the measurement quantity for measuring the neighboring resource IDs. The UE may then compare the RSSI of the resource IDs with the RSRP of the serving cell.

In another embodiment, the measurement report triggering condition might be such that the measurement report is triggered when the sum of SRS-RSRP or RSSI from a set of resource IDs is bigger than a threshold. Another condition may be that a configured certain number of resource IDs should have an SRS-RSRP that is larger than a threshold.

In another embodiment the measurement reporting configuration may be configured with a so-called reportOnLeave, meaning that the measurement reporting configuration sends a measurement when leaving the event condition.

In some embodiments, the measurement report may contain the resource IDs or a group of resource IDs of the measurement resource instead of the physical cell ID. In other embodiments, one or more resource IDs may be associated with an ID of a neighboring cell which may or may not be a physical cell ID.

In some embodiments, the measurement report may contain the UE IDs of the UEs instead of the physical cell ID. In some embodiments, the measurement configuration may contain a timing offset of the specific resource, such that the UE is instructed to perform measurements with the configured timing offset relative to a reference timing.

In some embodiments, the UE simply reports “CLI detected”. In some embodiments, only information (such as signal strength) about the strongest, or the few strongest, detected signals is reported or the measurements of all configured resource IDs are reported. The measurement report may contain the position of the reporting UE which can be reported as locationInfo or similar, allowing for the network to be able to see in which areas the interference is an issue. The reported information may also be any combination of the embodiments above.

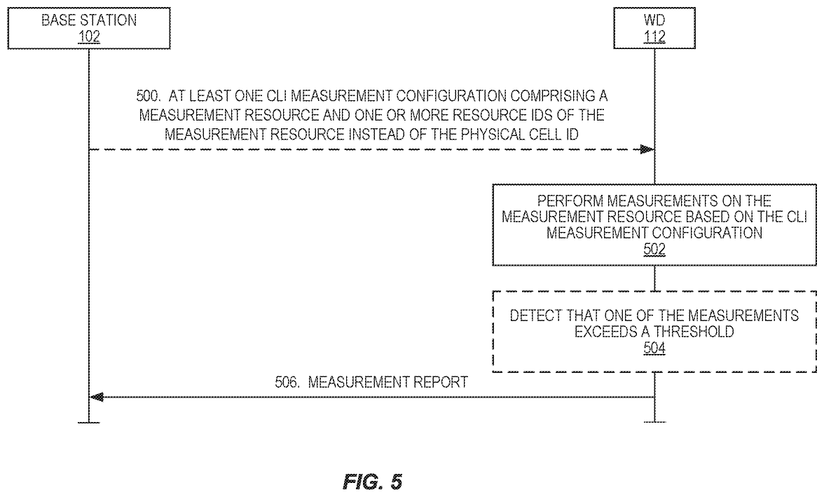

FIG. 6 is a schematic block diagram of a radio access node 600 according to some embodiments of the present disclosure. The radio access node 600 may be, for example, a base station QQ102 or QQ106. As illustrated, the radio access node 600 includes a control system 602 that includes one or more processors 604 (e.g., Central Processing Units (CPUs), Application Specific Integrated Circuits (ASICs), Field Programmable Gate Arrays (FPGAs), and/or the like), memory 606, and a network interface 608. The one or more processors 604 are also referred to herein as processing circuitry. In addition, the radio access node 600 includes one or more radio units 610 that each includes one or more transmitters 612 and one or more receivers 614 coupled to one or more antennas 616. The radio units 610 may be referred to or be part of radio interface circuitry. In some embodiments, the radio unit(s) 610 is external to the control system 602 and connected to the control system 602 via, e.g., a wired connection (e.g., an optical cable). However, in some other embodiments, the radio unit(s) 610 and potentially the antenna(s) 616 are integrated together with the control system 602. The one or more processors 604 operate to provide one or more functions of a radio access node 600 as described herein. In some embodiments, the function(s) are implemented in software that is stored, e.g., in the memory 606 and executed by the one or more processors 604.

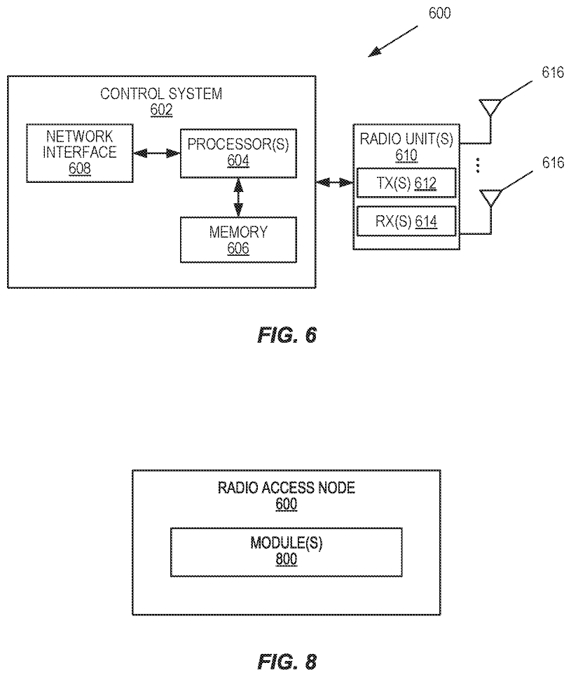

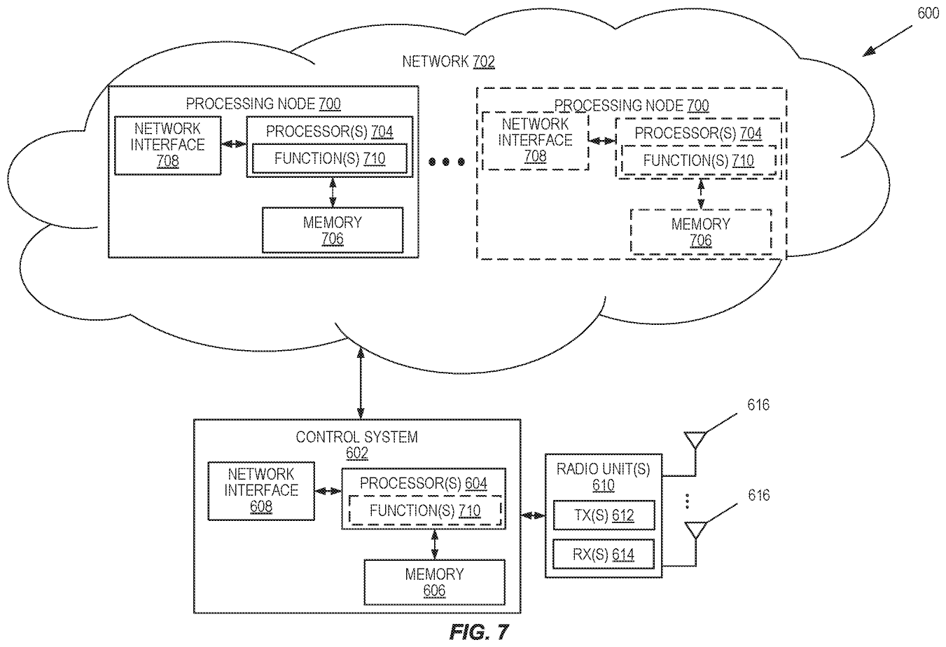

FIG. 7 is a schematic block diagram that illustrates a virtualized embodiment of the radio access node 600 according to some embodiments of the present disclosure. This discussion is equally applicable to other types of network nodes. Further, other types of network nodes may have similar virtualized architectures.

As used herein, a “virtualized” radio access node is an implementation of the radio access node 600 in which at least a portion of the functionality of the radio access node 600 is implemented as a virtual component(s) (e.g., via a virtual machine(s) executing on a physical processing node(s) in a network(s)). As illustrated, in this example, the radio access node 600 includes the control system 602 that includes the one or more processors 604 (e.g., CPUs, ASICs, FPGAs, and/or the like), the memory 606, and the network interface 608 and the one or more radio units 610 that each includes the one or more transmitters 612 and the one or more receivers 614 coupled to the one or more antennas 616, as described above. The control system 602 is connected to the radio unit(s) 610 via, for example, an optical cable or the like. The control system 602 is connected to one or more processing nodes 700 coupled to or included as part of a network(s) 702 via the network interface 608. Each processing node 700 includes one or more processors 704 (e.g., CPUs, ASICs, FPGAs, and/or the like), memory 706, and a network interface 708.

In this example, functions 710 of the radio access node 600 described herein are implemented at the one or more processing nodes 700 or distributed across the control system 602 and the one or more processing nodes 700 in any desired manner. In some particular embodiments, some or all of the functions 710 of the radio access node 600 described herein are implemented as virtual components executed by one or more virtual machines implemented in a virtual environment(s) hosted by the processing node(s) 700. As will be appreciated by one of ordinary skill in the art, additional signaling or communication between the processing node(s) 700 and the control system 602 is used in order to carry out at least some of the desired functions 710. Notably, in some embodiments, the control system 602 may not be included, in which case the radio unit(s) 610 communicate directly with the processing node(s) 700 via an appropriate network interface(s).

In some embodiments, a computer program including instructions which, when executed by at least one processor, causes the at least one processor to carry out the functionality of radio access node 600 or a node (e.g., a processing node 700) implementing one or more of the functions 710 of the radio access node 600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 8 is a schematic block diagram of the radio access node 600 according to some other embodiments of the present disclosure. The radio access node 600 includes one or more modules 800, each of which is implemented in software. The module(s) 800 provide the functionality of the radio access node 600 described herein. This discussion is equally applicable to the processing node 700 of FIG. 7 where the modules 800 may be implemented at one of the processing nodes 700 or distributed across multiple processing nodes 700 and/or distributed across the processing node(s) 700 and the control system 602.

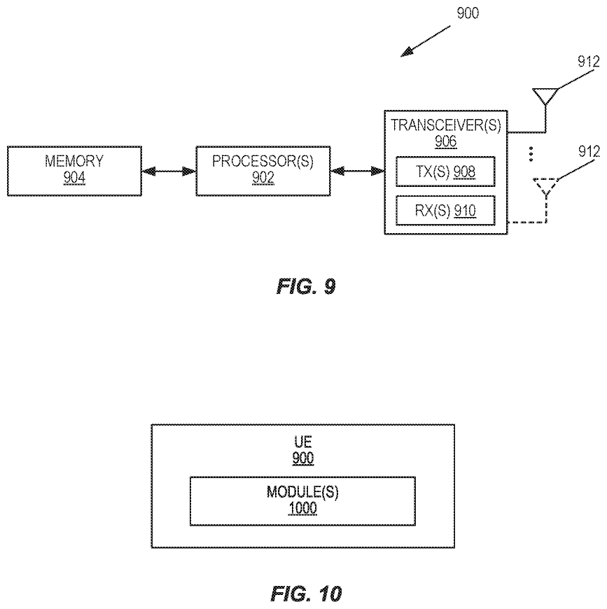

FIG. 9 is a schematic block diagram of a UE 900 according to some embodiments of the present disclosure. As illustrated, the UE 900 includes one or more processors 902 (e.g., CPUs, ASICs, FPGAs, and/or the like), memory 904, and one or more transceivers 906 each including one or more transmitters 908 and one or more receivers 910 coupled to one or more antennas 912. The transceiver(s) 906 includes radio-front end circuitry connected to the antenna(s) 912 that is configured to condition signals communicated between the antenna(s) 912 and the processor(s) 902, as will be appreciated by on of ordinary skill in the art. The processors 902 are also referred to herein as processing circuitry. The transceivers 906 are also referred to herein as radio circuitry. In some embodiments, the functionality of the UE 900 described above may be fully or partially implemented in software that is, e.g., stored in the memory 904 and executed by the processor(s) 902. Note that the UE 900 may include additional components not illustrated in FIG. 9 such as, e.g., one or more user interface components (e.g., an input/output interface including a display, buttons, a touch screen, a microphone, a speaker(s), and/or the like and/or any other components for allowing input of information into the UE 900 and/or allowing output of information from the UE 900), a power supply (e.g., a battery and associated power circuitry), etc.

In some embodiments, a computer program including instructions which, when executed by at least one processor, causes the at least one processor to carry out the functionality of the UE 900 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the UE 900 according to some other embodiments of the present disclosure. The UE 900 includes one or more modules 1000, each of which is implemented in software. The module(s) 1000 provide the functionality of the UE 900 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a wireless device for performing Cross-Link Interference, CLI, measurements, the method comprising:
receiving at least one CLI measurement configuration comprising a measurement resource and one or more resource Identities, IDs, of the measurement resource instead of a physical cell ID;
performing measurements on the measurement resource based on the CLI measurement configuration; and
upon detecting that one of the measurements exceeds a threshold:
transmitting a measurement report, where the measurement report comprises the measurement that exceeds the threshold and the one or more resource IDs of the respective measurement resource.

2. The method of claim 1 wherein detecting that the one of the measurements exceeds a threshold comprises comparing a Reference Signals Received Power, RSRP, of a Sounding Reference Signal, SRS, transmitted by a neighboring wireless device with a RSRP of a downlink reference signal transmitted by a serving cell of the neighboring wireless device.

3. The method of claim 1 wherein detecting that the one of the measurements exceeds a threshold comprises detecting that the measurement exceeds a threshold based on a comparison of different types of reference signals.

4. The method of claim 1 wherein detecting that the one of the measurements exceeds a threshold comprises detecting that the measurement becomes an offset larger than a RSRP of a downlink reference signal transmitted by a current serving cell.

5. The method of claim 2 wherein the downlink reference signal is a downlink reference signal transmitted by a cell serving an aggressor wireless device.

6. The method of claim 2 wherein the downlink reference signal is chosen from the group consisting of: a Channel State Information—Reference Signal, CSI-RS, and an Synchronization Signal Block, SSB.

7. The method of claim 1 wherein detecting that the one of the measurements exceeds a threshold comprises comparing a SRS-RSRP against a CSI-RSRP or an SSB-RSRP.

8. The method of claim 3 wherein the comparison of different types of reference signals comprises a comparison of two different types of reference signals using a RS-Type specific offset.

9. The method of claim 8 wherein the RS-Type specific offset is pre-defined for each possible different RS Type pairs that are compared.

10. The method of claim 8 wherein the RS-Type specific offset is configured as part of the at least one CLI measurement configuration.

11. The method of claim 10 wherein the RS-Type specific offset is implicitly signaled as part of a general offset which is configured as part of an event definition.

12. The method of claim 1 wherein detecting that the one of the measurements exceeds a threshold comprises comparing a Received Signal Strength Indicator, RSSI with the RSRP of a serving cell.

13. The method of claim 1 wherein detecting that the one of the measurements exceeds a threshold comprises detecting that a sum of SRS-RSRP or RSSI from a set of resource IDs exceeds a threshold.

14. The method of claim 1 wherein the at least one CLI measurement configuration is configured with reportOnLeave, meaning that the at least one CLI measurement configuration indicates that the measurement report should be transmitted when leaving an event condition.

15. The method of claim 1 wherein the at least one CLI measurement configuration comprise a timing offset of a specific measurement resource such that the wireless device is instructed to perform measurements with the configured timing offset relative to a reference timing.

16. The method of claim 1 wherein transmitting the measurement report comprises reporting only information about the strongest, or the few strongest, detected signals.

17. A method performed by a base station for receiving Cross-Link Interference, CLI, measurements, the method comprising:
transmitting, to a wireless device, at least one CLI measurement configuration comprising a measurement resource and one or more resource Identities, IDs, of the measurement resource instead of a physical cell ID; and
receiving a measurement report, where the measurement report comprises a measurement that exceeds a threshold and the one or more resource IDs of the respective measurement resource.

18. (canceled)

19. The method of claim 17 wherein the measurement report is based on the wireless device detecting that the measurement exceeds a threshold based on a comparison of different types of reference signals.

20-27. (canceled)

28. The method of claim 17 wherein the measurement report is based on comparing a Received Signal Strength Indicator, RSSI with the RSRP of a serving cell.

29-32. (canceled)

33. A wireless device for performing Cross-Link Interference, CLI, measurements, the wireless device comprising:
one or more processors; and
memory comprising instructions to cause the wireless device to:
receive at least one CLI measurement configuration comprising a measurement resource and one or more resource Identities, IDs, of the measurement resource instead of a physical cell ID;
perform measurements on the measurement resource based on the CLI measurement configuration; and
upon detecting that one of the measurements exceeds a threshold:
transmit a measurement report, where the measurement report comprises measurements that exceed the threshold and the one or more resource IDs of the respective measurement resource.

34-36. (canceled)
